(19) United States
(12) Patent Application Publication
(10) Pub. No.: US 2023/0013228 A1
(43) Pub. Date: Jan. 19, 2023

(54) CENTERED DOUBLE UNIVERSAL JOINT

(71) Applicant: Walterscheid GmbH, Lohmar (DE)

(72) Inventors: Martin Hector, Siegburg (DE); Matthias Littau, Alfter (DE)

(21) Appl. No.: 17/859,119

(22) Filed: Jul. 7, 2022

(30) Foreign Application Priority Data
Jul. 9, 2021 (EP) 21184817.1

(51) Int. Cl. F16D 3/32

(52) U.S. Cl. CPC F16D 3/32

(57) ABSTRACT

A centered double universal joint comprises
a housing having a first inner joint fork and a second inner joint fork,
a first outer joint fork hingedly connected to the first inner joint fork via a first trunnion cross,
a second outer joint fork hingedly connected to the second inner joint fork via a second trunnion cross,
an annular recess in the housing disposed about a longitudinal axis of the housing,
a guide disc that is guided in a radially adjustable manner in the annular recess of the housing,
the two outer joint forks being coupled in an articulated manner to the guide disc, and
two floating discs arranged in the axial direction on both sides of the guide disc in the annular recess,
wherein the housing, the floating discs or the guide disc is/are magnetized, exerting a magnetic force on the floating discs in the direction of the longitudinal axis.

### CROSS-REFERENCE TO RELATED APPLICATIONS

This application is a national stage of, and claims priority to, European Patent Application No. EP 21184817.1, filed on Jul. 9, 2021, which application is hereby incorporated herein by reference in its entirety.

### BACKGROUND

A centered double universal joint is known from EP 1 253 338 B1 and EP 1 277 979 B1. In the centered double universal joints described there, the two outer joint forks are each articulated via a trunnion cross to the two inner joint forks, which are each arranged on a bearing housing section. The bearing housing sections are welded together and define the annular recess in which the guide disc is radially displaceably mounted with the interposition of the floating annular floating discs. The guide disc has a central guide portion with centering projections on both sides. This has a central bore starting from its end faces. The outer joint forks, whose fork arms are connected by a bridge, each have a bearing journal that receives a bearing inner ring with a spherical outer surface. The bearing journal engages in the bearing bore of the guide portion of the guide disc and is supported there via a bearing outer ring with a spherical inner surface, which receives the spherical outer surface of the bearing inner ring. The inner and outer diameters of the floating discs are in such a ratio to the diameters of the annular recess and the guide disc that the annular recess is closed to the outside in all positions of displacement of the guide disc.

Due to the required radial play between the floating discs and the central guide portion of the guide disc on the one hand and the radial play between the floating discs and the annular recess on the other hand, the floating discs are accommodated with radial play in the annular recess at least in a not fully angled state of the double universal joint. This can cause the floating discs to move radially when the double universal joint is not fully angled, thus generating noise.

### SUMMARY

A centered double universal joint can have a housing with a first inner joint fork and a second inner joint fork, a first outer joint fork hingedly connected to the first inner joint fork via a first trunnion cross, and a second outer joint fork hingedly connected to the second inner joint fork via a second trunnion cross. An annular recess is disposed in the housing about a longitudinal axis of the housing. Furthermore, the centered double universal joint has a guide disc that is guided in a radially adjustable manner in the annular recess of the housing, with the two outer joint forks being coupled to the guide disc in an articulated manner. Two floating discs are arranged in the axial direction on both sides of the guide disc in the annular recess.

According to one aspect of the present disclosure a centered double universal joint has a housing with a first inner joint fork and a second inner joint fork, a first outer joint fork articulated to the first inner joint fork via a first trunnion cross, and a second outer joint fork articulated to the second inner joint fork via a second trunnion cross. An annular recess is disposed in the housing about a longitudinal axis of the housing. Furthermore, the centered double universal joint has a guide disc that is guided in a radially adjustable manner in the annular recess of the housing, with the two outer joint forks being coupled to the guide disc in an articulated manner. Two floating discs are arranged in the axial direction on both sides of the guide disc in the annular recess. The housing, the floating discs or the guide disc are magnetized exerting a magnetic force on the floating discs in the direction of the longitudinal axis.

The housing, the floating discs, or the guide disc, can each be magnetized as a whole or magnetized in areas. In the case of area magnetization, separate elements, such as permanent magnets, can be provided that are connected to the housing, the floating discs or the guide disc. This connection of separate elements is also to be understood as magnetization in the context of the present disclosure.

In the case of magnetization of the housing, the floating discs are each moved or pulled towards the housing axially along the longitudinal axis due to the magnetic forces. When the floating discs move radially to the longitudinal axis and relative to the housing, frictional forces are thus created between the floating discs and the housing, preventing or reducing free back-and-forth movement that would generate noise.

The same applies in the case of magnetization of the guide disc, in which the floating discs are moved axially along the longitudinal axis towards the guide disc, so that friction forces are generated between the floating discs and the guide disc during radial movement of the floating discs.

Alternatively, the floating discs can also be magnetized in such a way that they are either moved towards the housing or moved towards the guide disc and corresponding frictional forces are created.

The annular recess may be axially limited by a first guide surface and a second guide surface, each oriented perpendicular to the longitudinal axis.

The guide disc may have a first guide surface and a second guide surface facing away from each other and oriented perpendicular to the longitudinal axis. The guide disc is guided in a radially adjustable manner via the guide surfaces in the annular recess of the housing.

A first floating disc of the two floating discs can be arranged between the first guide surface of the annular recess and the first guide surface of the guide disc. Further, a second floating disc of the two floating discs may be disposed between the second guide surface of the annular recess and the second guide surface of the guide disc.

If the magnetization is provided in such a way that the floating discs are each drawn to the guide surface in the annular recess, a frictional force is created between the guide surface in the annular recess and the floating discs when the guide disc moves radially. If, on the other hand, the magnetization is designed in such a way that the floating discs are attracted to the guide disc, frictional forces arise between the floating discs and the guide surfaces of the guide disc when the floating discs move radially.

In an exemplary embodiment, it may be provided that at least one magnet is embedded in each of the first guide surface and the second guide surface of the annular recess or in the first guide surface and the second guide surface of the guide disc or in the floating discs.

The at least one magnet can be seated in a recess which opens into the respective guide surface or in a surface of the respective floating disc.

The at least one magnet can be flush with the respective guide surface or surface. To avoid wear of the magnet, it can also be provided that it is arranged set back from the respective guide surface or surface.

In one embodiment, the at least one magnet may have a cylindrical outer contour, wherein the recess is complementary to the outer contour of the magnet. In particular, the recess can be designed as a blind hole.

The at least one magnet can be held in the respective recess solely by its magnetic force. However, it is also conceivable that the at least one magnet is held by a form-fit or material-fit connection. For example, the at least one magnet may be glued.

In one embodiment, a plurality of magnets may be provided that are distributed around the circumference, in particular evenly distributed around the circumference.

The magnets can be arranged at different distances from the longitudinal axis around the circumference.

The at least one magnet can be a permanent magnet.

### BRIEF SUMMARY OF THE DRAWINGS

Embodiments of a centered double universal joint are explained in more detail below with reference to the drawings, in which

FIG. 1 is a perspective longitudinal section of a centered double universal joint,

FIG. 2 is a part of a longitudinal cross-section of the centered double universal joint according to FIG. 1 in the area of the annular recess with magnets in the centering disc,

FIG. 3 is a part of a longitudinal cross-section of the centered double universal joint according to FIG. 1 in the area of the annular recess with magnets in the floating discs,

FIG. 4 is a front view of the first bearing housing section of the double universal joint according to FIG. 1,

FIG. 5 is a front view of another embodiment of a first bearing housing section,

FIG. 6 is a perspective view of the centering disc according to FIG. 2 and

FIG. 7 is a front view of the centering disc as shown in FIG. 2.

### DESCRIPTION

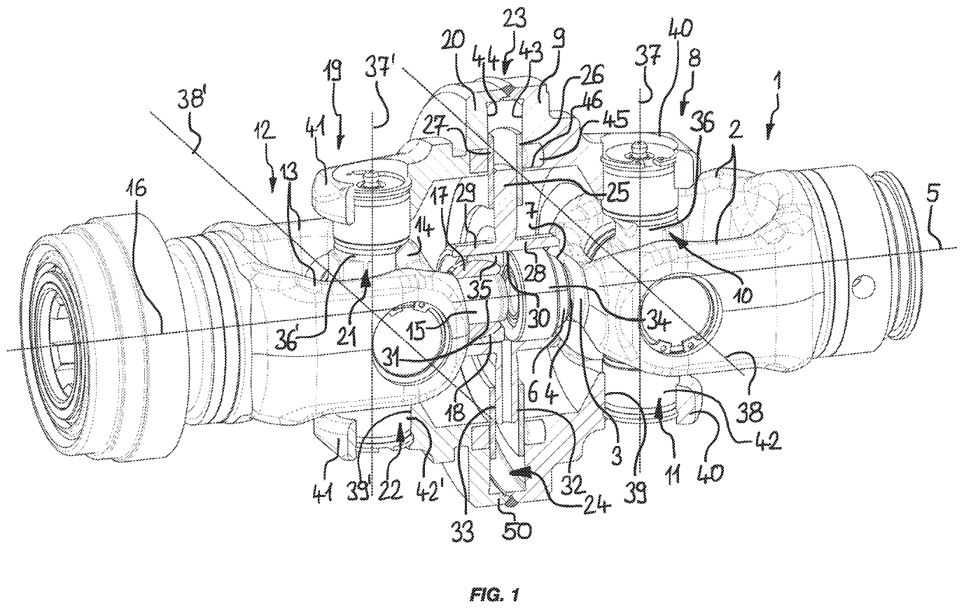

In FIGS. 1, a double universal joint is shown in partial section in a perspective side view. The double universal joint has a housing 23 with two individual universal joints, which are connected to each other via a centering mechanism in such a way that both joints each assume half the deflection angle when an input shaft is angled away from an output shaft, thereby ensuring constant velocity. Both universal joints have essentially the same design.

The first universal joint of the double universal joint comprises a first outer joint fork 1 with two first outer fork arms 2 connected by a first bridge 3 at their free ends. The first bridge 3 carries a first bearing journal 4 with a first axis 5. The bearing journal 4 is cylindrical on its outer surface. On the first bearing journal 4, a first bearing inner ring 6, which has the shape of a spherical layer with a spherical outer surface 7, is held non-displaceably along the first axis 5. The first outer joint fork 1 is hinged to the first inner joint fork 8 via a first trunnion cross 10 by means of rolling bearings 11. The first inner joint fork 8 is integrally formed with its two first inner fork arms 40 with a first bearing housing section 9.

The second joint includes a second outer joint fork 12 having two second outer fork arms 13. The two second fork arms 13 are connected to each other by a second bridge 14. The second bridge 14 carries a second bearing journal 15, which has a cylindrical outer surface and is centered on the second axis 16. On the second bearing journal 15, a second bearing inner ring 17 is held axially non-displaceable along the second axis 16. The second bearing inner ring 17 has a spherical outer surface 18. The second outer joint fork 12 is articulated to the fork arms 13 of the second inner joint fork 19 via a second trunnion cross 21 by means of rolling bearings 22. The second inner joint fork 19 is integrally formed with a second bearing housing section 20 by its two second inner fork arms 41.

The first bearing housing section 9 and the second bearing housing section 20 together form the housing 23, and are welded together, but may also be connected together in other ways, such as by fastening screws. The two bearing housing sections 9, 20 together form a radially outwardly closed and radially inwardly open annular recess 24, in which a guide disc 25 together with a first floating disc 26 and a second floating disc 27, which are arranged on both sides of the guide disc 25, are received in a radially adjustable manner between an annular first guide surface 54 and an annular second guide surface 55 of the annular recess 24. The annular recess 24 is axially limited by a first guide surface 43 and a second guide surface 44, which are opposite each other. The first floating disc 26 is disposed between and guided by the first guide surface 43 of the annular recess 24 and the first guide surface 32 of the guide disc 25. The second floating disc 27 is disposed between and guided by the second guide surface 44 of the annular recess 24 and the second guide surface 33 of the guide disc 25.

The diameters of the two annular floating discs 26, 27, the guide disc 25 and the annular recess 24 are matched to each other in such a way that the adjustment of the guide disc 25 required due to the angular deflection can be carried out in the annular recess 24, the latter is held securely, and the annular recess is closed to the outside at every angular deflection. Accordingly, the largest diameter of the annular recess 24 is larger than the outer diameter of the two annular floating discs 26, 27 and larger than the outer diameter of the guide disc 25. The inner diameter of the two annular floating discs 26, 27 is smaller than the outer diameter of the guide disc 25. The guide disc 25 further includes a central first centering projection 28 and a second centering projection 29, each having a cylindrical bearing bore 30 with a longitudinal axis 31. (As shown in FIG. 1, the double universal joint is in a fully extended position, and therefore the axes 5, 16, and 31 are shown to be arranged coaxially, i.e., as common axes, or, put another way, the axes 5 and 16 are at respective 180 degree angles to the axis 31; it will be understood that the double universal joint could be angled so that the respective angles of the axes 5 and 16 to the axis 31 could be other than 180 degrees.) The first centering projection 28 protrudes over the first guide surface 32 and the second centering projection 29 protrudes over the second guide surface 33 of the guide disc 25. The smallest diameter of the annular recess 24 is larger than the outer diameter of the centering projections 28, 29. Furthermore, the inner diameter of the annular floating discs 26, 27 must also be correspondingly larger than the outer diameter of the centering projections 28, 29.

A first bearing outer ring 34 with a spherical bore sits on the first bearing inner ring 6 wherein the bore is adapted to the spherical outer surface 7 of the first bearing inner ring 6. The first bearing outer ring 34 is cylindrical in shape on the outside and is slidably guided in the bearing bore 30. Accordingly, the second bearing inner ring 17 is received with the spherical outer surface 18 in a corresponding spherical bore of a second bearing outer ring 35. The second bearing outer ring 35 is also slidably received in the bearing bore 30 with its cylindrical outer surface.

The two trunnion crosses 10, 21 each have four trunnions 36, 36′, two of which are arranged on a common trunnion axis 37, 38. The trunnions 36, 36′ are mounted in bores 39 of the fork arms 2, 13, 40, 41 by means of rolling bearings 11, 22. The rolling bearings 11, 22 each comprise a bearing sleeve 42 which is seated in the respective bore 39 and rolling elements (not shown) which roll on an outer surface of the respective trunnion 36, 36′ and an inner surface of the respective bearing sleeve 42.

Due to the required radial play between the floating discs 26, 27 and the central centering projections 28, 29 of the guide disc 25 on the one hand, and the radial play between the floating discs 26, 27 and the annular recess 24 radially outward on the other hand, the floating discs 26, 27 can move radially within the annular recess 24 at least in a not fully angled state of the double universal joint as shown in FIG. 1. This can cause the floating discs 26, 27 to radially abut the centering projections 28, 29 and/or the radially outer wall of the annular recess 24 and generate noise.

This is prevented in the embodiment shown in FIG. 1 by the housing 23 being magnetized. For this purpose, several magnets 45 in the form of permanent magnets are embedded in the first bearing housing section 9 of the housing 23 in the first guide surface 43 distributed over the circumference. Further, a plurality of magnets 45 in the form of permanent magnets are also circumferentially embedded in the second bearing housing section 20 of the housing 23 in the second guide surface 44. The magnets 45 are each seated in a recess 46 that opens into the respective guide surface 43, 44. The magnets 45 are flush with or slightly recessed from the respective guide surface 43, 44.

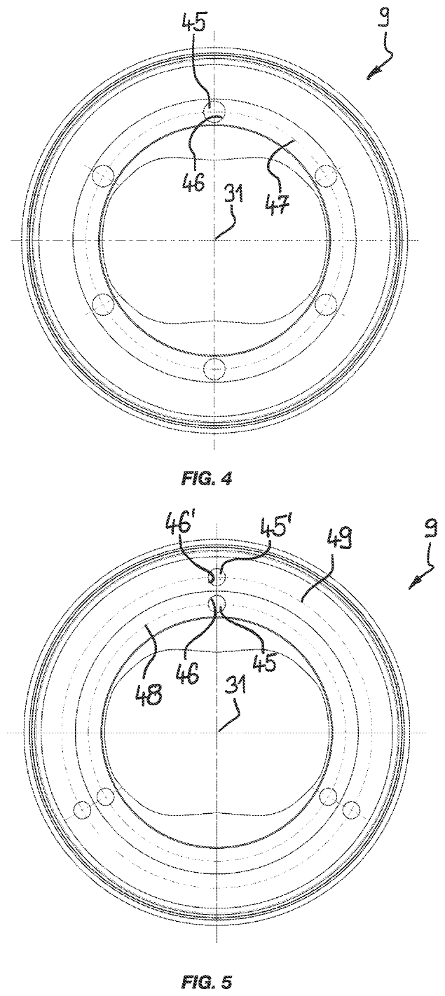

FIG. 4 shows the first bearing housing section 9 in a front view. Here it can be seen that a total of six magnets 45 are evenly spaced around the circumference of a circle 47.

FIG. 5 shows an alternative embodiment of the first bearing housing 9 in a front view. Here, a total of three magnets 45 are evenly spaced around the circumference of an inner circle 48. In addition, three further magnets 45′ are evenly distributed around the circumference of an outer circle 49, the magnets 45′ on the outer circle 49 having the same angular position as the magnets 45 on the inner circle 48.

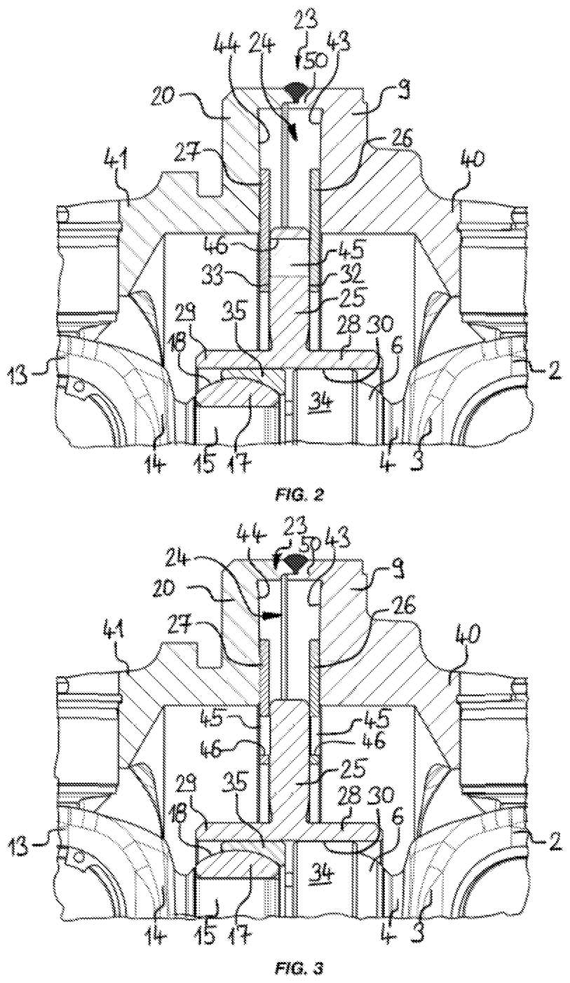

FIG. 2 shows a section of a longitudinal cross-section of the centered double universal joint still in FIG. 1, wherein not the housing 23, but the guide disc 25, is magnetized. For this purpose, several magnets 45 in the form of permanent magnets are embedded in the guide disc 25 distributed over the circumference. For this purpose, recesses 46 are provided in the guide disc 25, which run parallel to the longitudinal axis 31 and completely penetrate the guide disc 25. In this case, the magnets 45 can be aligned with the first guide surface 32 and the second guide surface 33 of the guide disc, respectively, or can be arranged offset from them. Alternatively, it is also conceivable that the recesses 46 each extend from or open into only one of the guide surfaces 32, 33 of the guide disc 25 and are formed as blind holes. Thus, on the one hand, recesses 46 would have to be provided which open into the first guide surface 32 of the guide disc 25 and, on the other hand, recesses 46 would have to be provided which open into the second guide surface 33 of the guide disc 25.

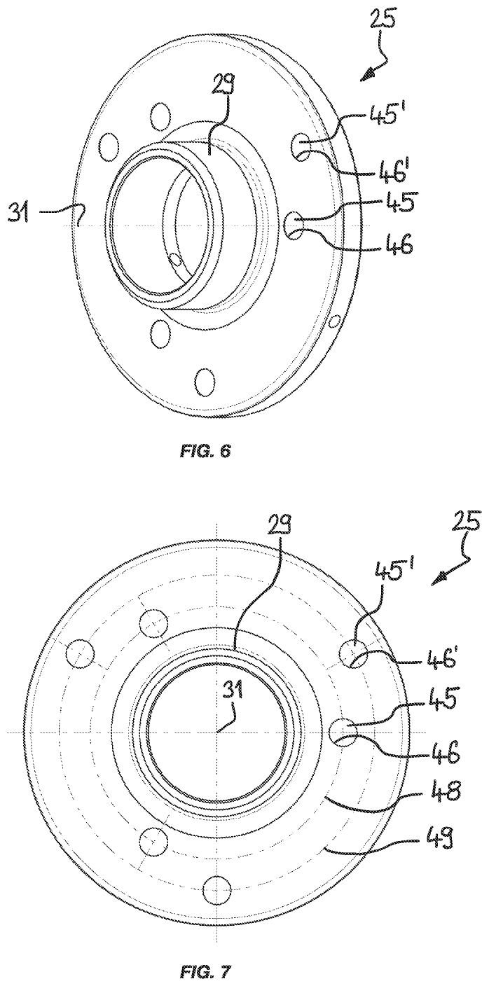

FIGS. 6 and 7 show the guide disc 25 in different views. It can be seen that, on the one hand, three magnets 45 are arranged uniformly distributed on an inner circle 48 and, on the other hand, three magnets 45′ are arranged uniformly distributed on an outer circle 49. The magnets 45′ on the outer circle 49 are arranged over the circumference angularly offset to the magnets 45 on the inner circle 48.

FIG. 3 shows a sectional view of the centered double universal joint shown in FIG. 1, with neither the housing 23 nor the guide disc 25 magnetized. Rather, in this embodiment, the floating discs 26, 27 are magnetized. For this purpose, several magnets 45 in the form of permanent magnets are embedded in the floating discs 26, 27 distributed over the circumference. For this purpose, recesses 46 are provided in the floating discs 26, 27, which run parallel to the longitudinal axis 31 and completely penetrate the floating discs 26, 27. The magnets 45 can be aligned with the surfaces of the floating discs 26, 27, or set back from them.

### LIST OF REFERENCE SIGNS

1 first outer joint fork

2 first outer fork arm

3 first bridge

4 first bearing journal

5 first axis

6 first bearing inner ring

7 spherical outer surface

8 first inner joint fork

9 first bearing housing section

10 first trunnion cross

11 rolling bearing

12 second outer joint fork

13 second outer fork arms

14 second bridge

15 second bearing journal

16 second axis

17 second bearing inner ring

18 spherical outer surface

19 second inner joint fork

20 second bearing housing section

21 second trunnion cross

22 rolling bearing

23 housing

24 annular recess

25 guide disc

26 first floating disc

27 second floating disc

28 first centering projection

29 second centering projection

30 bearing bore

31 longitudinal axis

32 first guide surface of the guide disc

33 second guide surface of the guide disc

34 first bearing outer ring

35 second bearing outer ring

36, 36′ trunnion

37, 37′ trunnion axis

38, 38′ trunnion axis

39, 39′ bore

40 first inner fork arm

41 second inner fork arm

42, 42′ bearing bushing

43 first guide surface of the annular recess

44 second guide surface of the annular recess

45, 45′ magnet

46, 46′ recess

47 circle

48 inner circle

49 outer circle

1.-13. (canceled)

14. A centered double universal joint, comprising:
a housing including a first inner joint fork and a second inner joint fork;
a first outer joint fork hingedly connected to the first inner joint fork via a first trunnion cross;
a second outer joint fork hingedly connected to the second inner joint fork via a second trunnion cross;
an annular recess in the housing disposed about a longitudinal axis of the housing;
a guide disc that is guided in a radially adjustable manner in the annular recess of the housing, the two outer joint forks being coupled in an articulated manner to the guide disc; and
two floating discs arranged, on both sides of the guide disc in a direction of the longitudinal axis, in the annular recess;
wherein one or more of the housing, the floating discs, or the guide disc is magnetized, exerting a magnetic force on the floating discs in the direction of the longitudinal axis.

15. The centered double universal joint of claim 14, wherein the annular recess is axially limited by a first guide surface and a second guide surface.

16. The centered double universal joint of claim 15, wherein the guide disc has a first guide surface and a second guide surface, via which the guide disc is guided in a radially adjustable manner in the annular recess of the housing.

17. The centered double universal joint of claim 16,
wherein a first floating disc of the two floating discs is arranged between the first guide surface of the annular recess and the first guide surface of the guide disc; and
wherein a second floating disc of the two floating discs is arranged between the second guide surface of the annular recess and the second guide surface of the guide disc.

18. The centered double universal joint of claim 17, wherein at least one magnet is inserted into each of the first guide surface and the second guide surface of the annular recess, or into each of the first guide surface and the second guide surface of the guide disc, or into each of the floating discs.

19. The centered double universal joint of claim 18, wherein the at least one magnet is seated in a recess which opens into the respective guide surface.

20. The centered double universal joint of claim 19, wherein the at least one magnet is flush with the respective guide surface, or is arranged set back relative thereto.

21. The centered double universal joint of claim 20, wherein the at least one magnet has a cylindrical outer contour and the recess is complementary to the outer contour of the magnet.

22. The centered double universal joint of claim 19, wherein the at least one magnet is held in the respective recess exclusively by its magnetic force.

23. The centered double universal joint of claim 18, wherein several magnets are arranged distributed over the circumference.

24. The centered double universal joint of claim 23, wherein the magnets are evenly distributed around the circumference.

25. The centered double universal joint of claim 23, wherein the magnets are arranged at different distances to the longitudinal axis distributed over the circumference.

26. The centered double universal joint of claim 19, wherein the at least one magnet is a permanent magnet.
